(19) United States
(12) Patent Application Publication
(10) Pub. No.: US 2015/0330040 A1
(43) Pub. Date: Nov. 19, 2015

(54) ROADWAY DELINEATOR AND SAFETY SYSTEM

(71) Applicant: Blaine Alan Dobbs, Sugar Land, TX (US)

(72) Inventor: Blaine Alan Dobbs, Sugar Land, TX (US)

(21) Appl. No.: 14/712,314

(22) Filed: May 14, 2015

Related U.S. Application Data
(60) Provisional application No. 61/994,013, filed on May 15, 2014.

(51) Int. Cl. E01F 9/016; F21V 15/01; F21L 4/08; E01F 9/011; E01F 13/00

(52) U.S. Cl. CPC E01F 9/016; E01F 9/0112; E01F 13/00; F21L 4/08; F21V 15/01

(57) ABSTRACT

Embodiments of the present disclosure relate to roadway delineators with one or more light sources that provide illumination and increased visibility. In accordance with one implementation, the delineator includes a mounting apparatus that provides both a mounting surface and structural support. In addition, the delineator may be self-powered and include a solar array and/or a rechargeable power source for the one or more light sources. Multiple delineators may be used together with a roadway barrier to create a roadway safety system.

### CROSS-REFERENCE TO RELATED APPLICATION

This application claims the benefit of priority to U.S. Provisional Application No. 61/994,013, filed on May 15, 2014, the entire disclosure of which is expressly incorporated herein by reference.

### BACKGROUND

1. Technical Field

The present disclosure relates generally to roadway reflectors and safety equipment. More particularly, and without limitation, the present disclosure relates to a roadway barrier-top solar-powered delineator, and methods and systems for implementation of multiple delineators.

2. Background

Drivers often fail to notice roadway features or dangers in low-visibility conditions, such as fog, clouds, rain, or the dark of night. To alert drivers to these features or dangers, reflectors are often used. Reflectors passively reflect light from vehicle headlights, indicating roadway features and obstacles to oncoming drivers. Because conventional reflectors do not generate any light on their own, reflectors operate poorly if the incident light is dim or obstructed. Passive reflectors are, therefore, most useful in clear conditions. Even so, reflectors may not provide sufficient indication of a roadway at long distances even in the best conditions. Moreover, Fog, heavy rain, and/or other weather conditions reflectors may fail to delineate roadway features. Similarly, if cars have damaged headlights, or if the reflector itself is dirty, the reflector may be insufficient to warn drivers or otherwise be recognized. Moreover, in well-lit construction sites and other areas, reflectors leave barriers all but unmarked, as the small reflection pales in comparison to ambient safety lighting.

Aiming to address these problems, several known devices use active light sources to indicate roadway features or dangers. For example, U.S. Pat. No. 5,252,893 discloses a rechargeable electronic flasher powered by a solar panel and a solar-rechargeable battery. Similarly, U.S. Pat. No. 8,210,719 discloses a solar-powered indicator for road railings. The devices of these patents use light-emitting diodes (LEDs) and passive reflectors to signal road dangers.

Though these devices solve some problems of traditional reflectors, they create others. For example, such indicators may have bulky, voluminous bodies. Shipping such devices can increase costs, as they require large volumes to pack few devices. Further, devices designed for specialized installation environments may work poorly outside of their designated environments. For example, a device disclosed in U.S. Pat. No. 5,252,893 is intended for roadway surfaces. Such devices may work poorly to delineate roadway barriers.

Further, while current LED devices may provide additional safety over passive reflectors, they are expensive to manufacture. While passive reflectors cost less to manufacture, they do not offer the safety features of an LED device. Presented herein are embodiments of solar-powered LED delineators that may be inexpensively manufactured while providing greater safety and reliability than previous devices. Further, presented herein are embodiments of solar-powered delineators that provide durable, modular housings capable of various configurations and uses.

### SUMMARY

Embodiments of the present disclosure may be implemented to provide roadway reflectors and safety equipment. In some embodiments, a roadway barrier-top solar-powered delineator is provided. The delineator may include one or more LEDs or other light sources that can indicate road features or dangers. The delineator may further include various communication and sensing instruments that may control the operation of one or more delineators, and that may enable communication of one or more delineators with other delineators or other communication devices.

In accordance with some embodiments, a delineator is provided that may be attached to a roadway barrier. The roadway delineator may comprise a housing having a top member, a front member, and a back member. In at least one embodiment, the front member has a substantially vertical exterior surface defining a height and a width, and an interior surface opposite the exterior surface. In this embodiment, the top member is in a plane substantially perpendicular to the front member and has an exterior horizontal surface defining a depth, the depth being no greater than one half the height.

In some embodiments, the delineator includes a solar cell array positioned on the top member, a rechargeable power source, and a light source positioned on the front exterior surface. The light source is electrically connected to the solar cell array and the power source. The delineator also includes a processor regulating electrical power between the solar cell array, the power source, and the light source.

According to still further embodiments, the delineator includes a foot having a horizontal mounting member extending parallel to the top member, and a vertical member affixed to the interior surface of the front member.

It is to be understood that both the foregoing general description and the following detailed description are exemplary and explanatory only and are not restrictive of the embodiments of the present disclosure, as claimed.

### BRIEF DESCRIPTION OF THE DRAWINGS

The accompanying drawings, which are incorporated in and constitute a part of this specification, illustrate several embodiments of the present disclosure and, together with the description, serve to explain the principles and features of the present disclosure.

FIG. 1 is a perspective view of an exemplary solar-powered safety device, consistent with embodiments of the present disclosure.

FIG. 2 is a perspective view of an exemplary solar-powered safety system, consistent with embodiments of the present disclosure.

FIG. 3 is an isolated view of an exemplary foot, consistent with embodiments of the present disclosure.

FIG. 4 is a perspective view of an exemplary roadway safety system, in an exploded view, consistent with embodiments of the present disclosure.

FIG. 5 is a perspective view of an exemplary solar-powered roadway delineator, consistent with the embodiments of the present disclosure.

### DETAILED DESCRIPTION OF EXEMPLARY EMBODIMENTS

Reference will now be made in detail to embodiments of the present disclosure, examples of which are illustrated in the accompanying drawings. Wherever possible the same reference numbers will be used throughout the drawings to refer to the same or like parts.

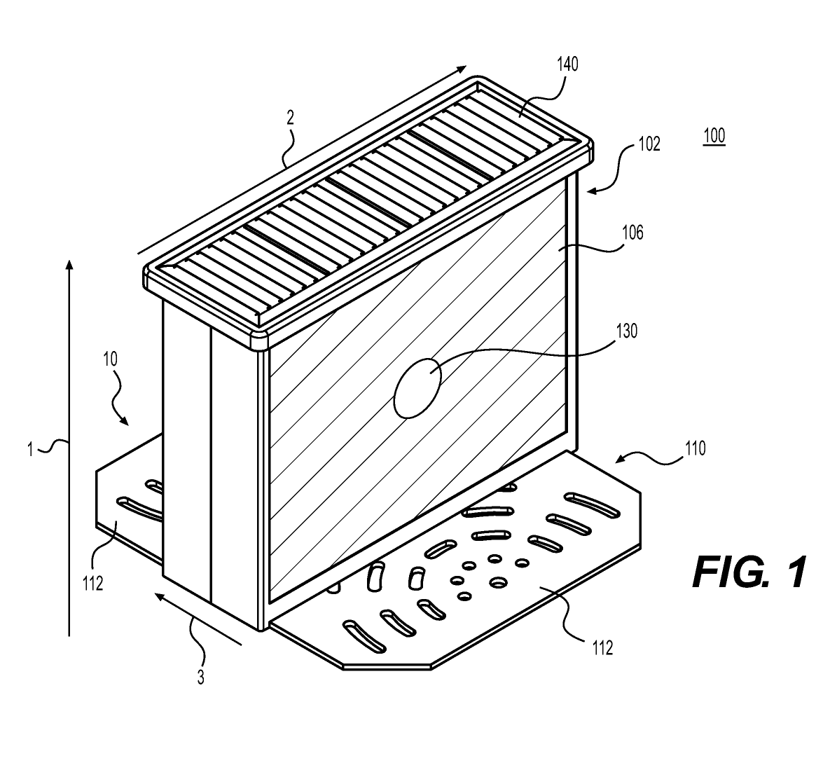

FIG. 1 is a perspective view of an exemplary solar powered roadway delineator 100, shown in assembled form. Delineator 100 comprises a housing having a top member, a front member, and a back member, in the form of body 102. In some embodiments body 102 is made of plastic. In other embodiments, body 102 may be made of metal, aluminum, 3D printed materials, or otherwise, including any low-cost and/or resilient material.

Delineator 100 further comprises a foot having a horizontal mounting member extending parallel to the top member and a vertical member affixed to the interior surface of the front member, in the form of two feet 110. Feet 110 each include horizontal members 112 protruding from the bottom edge of body 102. When mounted, the underside of feet 110 may lie flat against a surface of a roadway barrier. Feet 110 may also be configured to fit the contours of a mounting surface.

FIG. 1 further discloses delineator 100 comprising the front member having a substantially vertical exterior surface defining a height 1 and a width 2 and an interior surface opposite the exterior surface and the top member being in a plane substantially perpendicular to the front member and having an exterior horizontal surface defining a depth 3, the depth 3 being no greater than one half the height 1, in the form of body 102.

Delineator 100, in one exemplary embodiment, is approximately four inches in height 1, over four inches in width 2, and less than one inch in depth 3. The height 1 and width 2 are thus over four times greater than the depth 3. This ratio may provide several advantages. First, the ratio allows for a relatively large surface area of reflective sheeting 106. Second, the ratio allows for a relatively reduced amount of material to be used to make delineator 100. And third, the ratio allows for a device with a thin profile in one dimension, which reduces wind strain in that dimension.

FIG. 1 further discloses a solar cell array positioned on the top member, in the form of a solar panel 140 attached to top of body 102. The housing of delineator 100 further comprises a light source positioned on the front exterior surface, in the form of an optical lens 130, which may house one or more light sources. In other embodiments, one or more optical lenses 130 may protrude through multiple sides of delineator 100. In even more embodiments, one or more optical lenses 130 may be positioned to protrude through the top of body 102, and/or through solar panel 140. Solar panel 140 may also be positioned on the side, front, or back of delineator 100. For instance, delineator 100 may be mounted on the side of a roadway barrier so that it sits at an angle. An embodiment of delineator 100 may place solar panel 140 on a side of body 102, so that the panel faces upwards when delineator 100 is mounted to the barrier. Further, a plurality of solar panels 140 may be attached to delineator 100 in various configurations.

Delineator 100 may also delineate roadway barriers by passive reflection or light emission. For example, the body 102 may be turned so that reflective sheeting 106 and optical lens 130 face approaching drivers. Reflective sheeting 106 may be a passive reflector, and may reflect light back toward oncoming vehicles, while a light source within optical lens 130 emits light when activated. By providing both passive reflective and active light sources, delineator 100 may provide additional delineation of highway obstacles, such as a roadway barrier.

Horizontal members 112 may include one or many mounting features, including a plurality of holes to facilitate mechanical and/or adhesive mounting. Delineator 100 may thus be mounted on roadway barriers using mechanical mounting devices, such as bolts, nails, screws, rivets, staples, and the like and/or epoxies and adhesives. The number and size of the holes may allow for a variety of structural and mounting options. For example, reducing the number or size of holes in horizontal members 112 may decrease machining costs and increase mechanical strength of the foot. Increasing the number and size of holes provides greater space for epoxy to seep through and may increase the strength and security of the attachment of delineator 100 to the barrier. The embodiment shown in FIG. 1 allows for a large amount of bonding surface area by including several rows of arched openings in horizontal member 112 to allow epoxy to flow through from the underside if delineator 100 is attached to a surface. In further embodiments, holes in horizontal member 112 may be configured to allow for a metal band clamp, or similar device, to be attached to delineator 100. This configuration may allow the delineator to be securely attached to a round or oval tube pipe. In still further embodiments, a delineator 100 may include configurations to allow for attachments to a variety of surfaces. Variations in the design of foot 110, body 102, or other components of delineator 100 may facilitate such attachments.

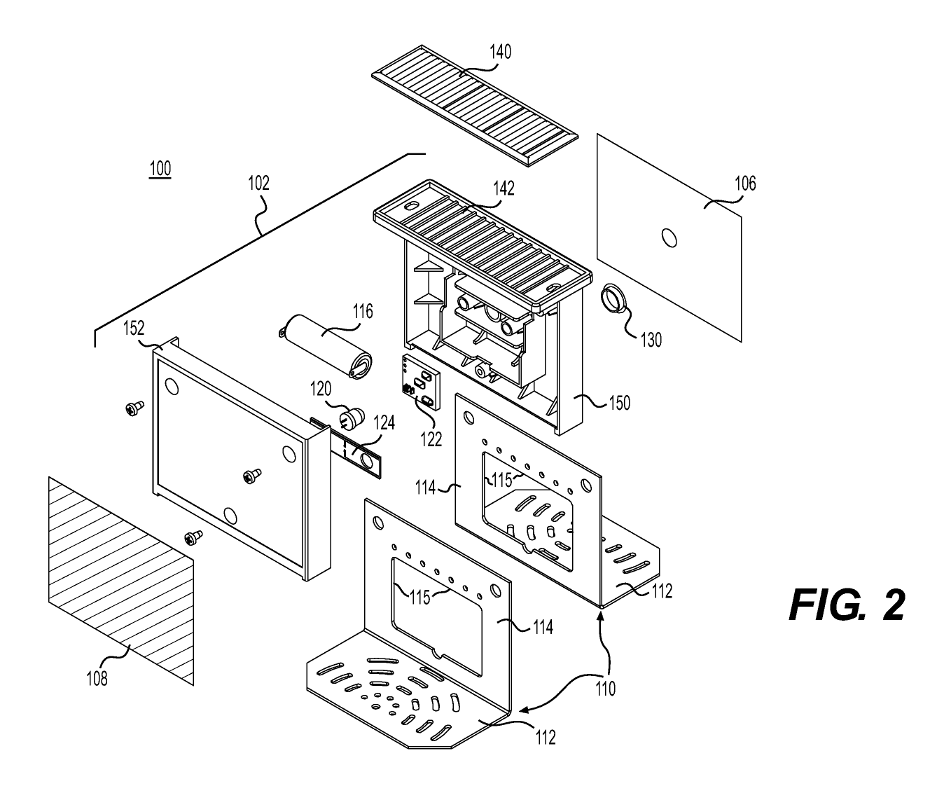

FIG. 2 is an exploded perspective view of delineator 100, which discloses body 102 comprising a master body enclosure 150 and a back panel 152. Delineator 100 further includes a printed circuit board (hereinafter “PCB”) 124 and a light source in the form of LED 120 attached to PCB 124. LED 120 (or another light source) nests behind optical lens 130, which attaches to the exterior surface of master body enclosure 150. Reflective sheeting 108 may be attached to back cover 152 by adhesive or other means. Reflective sheeting 108 may be, in other embodiments, a hard plastic reflector, a metal reflector, or any other reflector. In one embodiment shown in FIG. 2, reflective sheeting 106 includes a hole in its center to accommodate optical lens 130, while reflective sheeting 108 may be a full sheet with no holes. In other embodiments, reflective sheets may include a plurality of holes to allow a plurality of light sources and other devices to protrude. When assembled, LED 120 emits light through optical lens 130. Optical lens 130 may diffuse or focus light, depending on the application. Optical lens 130 may also vary the color of light emitted from the delineator. Further still, one or a plurality of LEDs 120 may emit one or more colors that may be mixed by optical lens 130. In some embodiments, a plurality of LEDs 120 and optical lenses 130 may be provided.

Delineator 100 also includes a rechargeable power source, in the form of rechargeable battery 116, for example. Electrical connections connect the light source, the solar cell array, and the power source. For example, electrical connections may connect LED 120, solar panel 140, and rechargeable battery 116. Delineator 100 may further include one or more electrical processor or microprocessor (hereinafter “processor”) which may control electrical power between the solar cell array, the power source, and the light source, in the form of a charge controller PCB 122. For example, charge controller PCB 122 may be designed so that LED 120 will light at a predetermined time. Or charge controller PCB 122 may be programmed for LED 120 to light if the external light falls below a certain level, such as at night or in a heavy fog. Further, delineator 100 may include a light sensor coupled to the processor wherein the processor may be configured to illuminate the light source when the ambient lighting falls below a predetermined level.

FIG. 2 further discloses details of feet 110. Feet 110 may be made of metals, hard plastics, or other materials, and includes both a horizontal member 112 and a vertical member 114. Vertical member 114 may provide lateral support to delineator 100. For example, delineator 100 may be installed along a highway, where passing vehicles create high-velocity winds. When the wind hits the front surface of delineator 100, it may create a large lateral force. Vertical member 114 may provide lateral support to delineator 100, so that it remains mounted and standing even if wind or another source applies a substantial force on delineator 100. Vertical member 114 may also include a hole on the vertical member, in the form of an approximately rectangular hole 115, to allow space for some of the electronics of an assembled delineator 100. Vertical member 114 of foot 110 may, in turn, provide some impact protection and structural support to the electronic components of delineator 100.

As shown in FIG. 2, feet 110 may be installed with horizontal members 112 facing opposite directions in an assembled delineator 100. In this configuration, vertical members 114 of feet 110 may work in opposition, supporting each other. This may provide even greater lateral support for delineator 100. Delineator 100, in other embodiments, may include only one foot or a plurality of feet in a plurality of directions, depending on the desired installation environment and delineator characteristics.

As further shown in FIG. 2, a set of ridges 142 may be provided along the top surface of master body enclosure 150. Ridges 142 may provide a mounting surface for solar panel 140. More particularly, ridges 142 may provide an expanded surface for improved adhesion of solar panel 140 to master body enclosure 150.

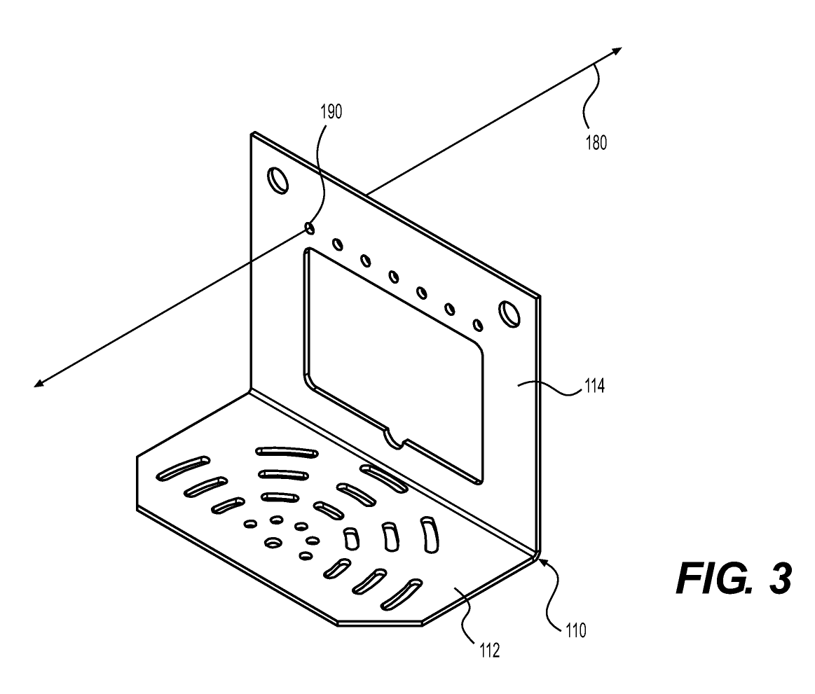

FIG. 3 shows an isolated view of foot 110, with vertical member 114 and horizontal member 112. Vertical member 114 includes hole 190 in foot 110 and a conductor 180 that passes through hole 190. Conductor 180 may be connected to a power source, including power storage devices, here shown in the form of rechargeable battery 116. Delineator 100 may include any suitable power source, for example a disposable battery or a capacitor. Conductor 180 may also be connected to a processor, in the form of charge controller PCB 122. Additional embodiments may include conductors 180 passed through a plurality of holes 190 in foot 110. Conductors 180 may be electrically connected to various components of delineator 100, including, but not limited to, a rechargeable power source, a solar cell array, a processor, RADAR, a PCB, an LED, a wireless communication device, a temperature sensor, a light sensor, and/or a thermocouple.

Further, wiring conductor 180 so as to pass through hole 190 in foot 110 may provide a potentially useful anti-theft feature of delineator 100. For example, delineator 100 may be configured so that an electrical connection severs if the device is forcibly removed from a mounted state. For example, delineator 100 may be configured so that an electrical connection from the power source or processor may be severed if the housing is separated from the foot. Further still, delineator 100 may comprise a safety component configured such that an electrical connection supplying the processor may be severed if delineator 100 is separated from the roadway barrier.

This and other features may protect against theft of Delineators 100. As Delineators 100 may be installed along highways in remote areas, without video or human supervision, the flashing lights and electronic components of delineator 100 may attract individuals. Some may attempt to take one or more delineators 100 without permission from the rightful owner. As delineators may be securely attached to a roadway barrier, an attempted removal of delineator 100 may apply force to body 102, which may separate body 102 from foot 110. For body 102 to be fully removed from foot 110, conductor 190 must be severed. And even if conductor 190 is not severed completely in attempting to remove body 102, the electrical connections may be disconnected from components including, but not limited to, a rechargeable power source, a solar cell array, a processor, a PCB, an LED, a wireless communication device, and a thermocouple. Disconnecting conductor 190 may render delineator 100 inoperable.

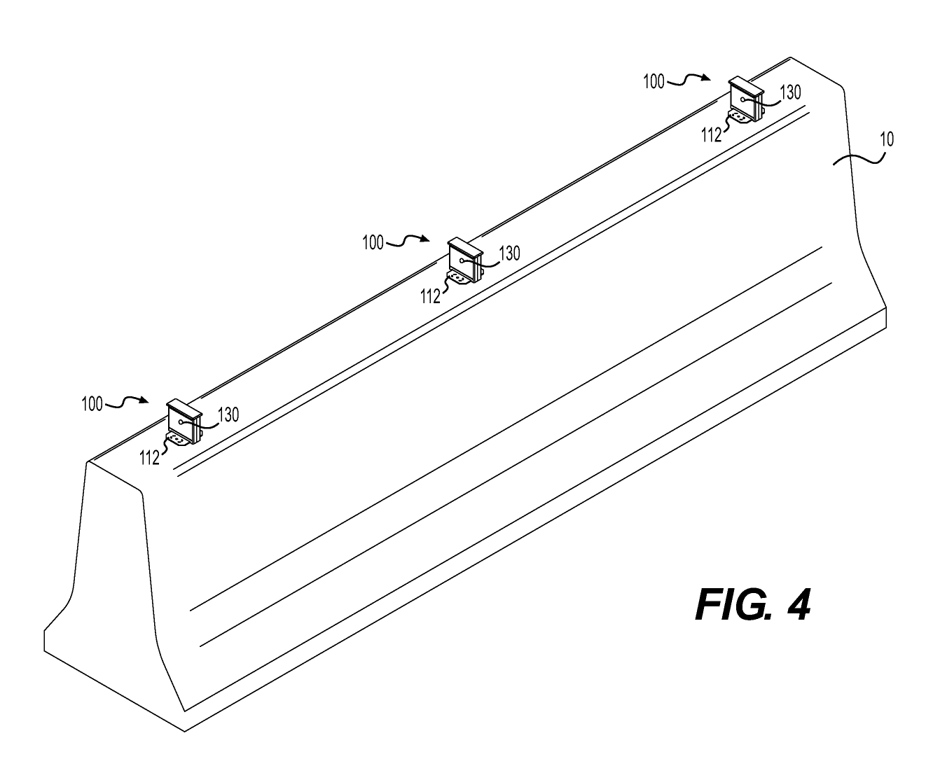

FIG. 4 is a perspective view of a plurality of delineators 100 securely attached to a barrier 10. The barrier 10 and delineators 100 form one embodiment of a roadway safety system. Delineators 100 may include a wireless communication device inside bodies 102 to allow delineators 100 to receive data from a wireless communication device capable of directing at least one of the plurality of delineators. The wireless communication device may be a control unit. In other embodiments, delineators 100 may also send data to a control unit or any wireless communication device, as well as to and from other delineators 100. Wireless communication may be accomplished through a variety of communication methods, including, but not limited to, WI-FI, radio frequency, RADAR, Bluetooth, infrared, induction, visual signals, and the like.

Light sources 120 of delineator 100 may emit light through optical lenses 130 and provide visible delineation at long distances and in adverse weather conditions. In accordance with some embodiments, delineators 100 may provide an easily installed, low maintenance, off-the-grid, self-powered, stand-alone, long-lasting nighttime illumination and marking system for use with barriers used on highways and rural roads to alert motorists to the presence of the barriers. Delineators 100, consistent with the present disclosure, can be used on straight stretches of highways and roads, as well as along curves and blind corners to facilitate safe traffic flow. Delineators 100, consistent with the present disclosure, can be used with concrete highway barriers, jersey-type barriers, precast barriers, constant slope barriers, traffic barriers, truck barriers, median barriers, crash barriers, as well as other environments. Delineators 100 may also be used with steel pipe railing, concrete traffic rail, concrete rigid barriers, bridge barriers, work zone barriers, impact barriers, fitch barriers, barrier end treatments, etc. Delineators 100 may also be used on municipal roadways and parking lots. Further, delineators 100, consistent with the present disclosure, may be used on vehicles, such as construction equipment.

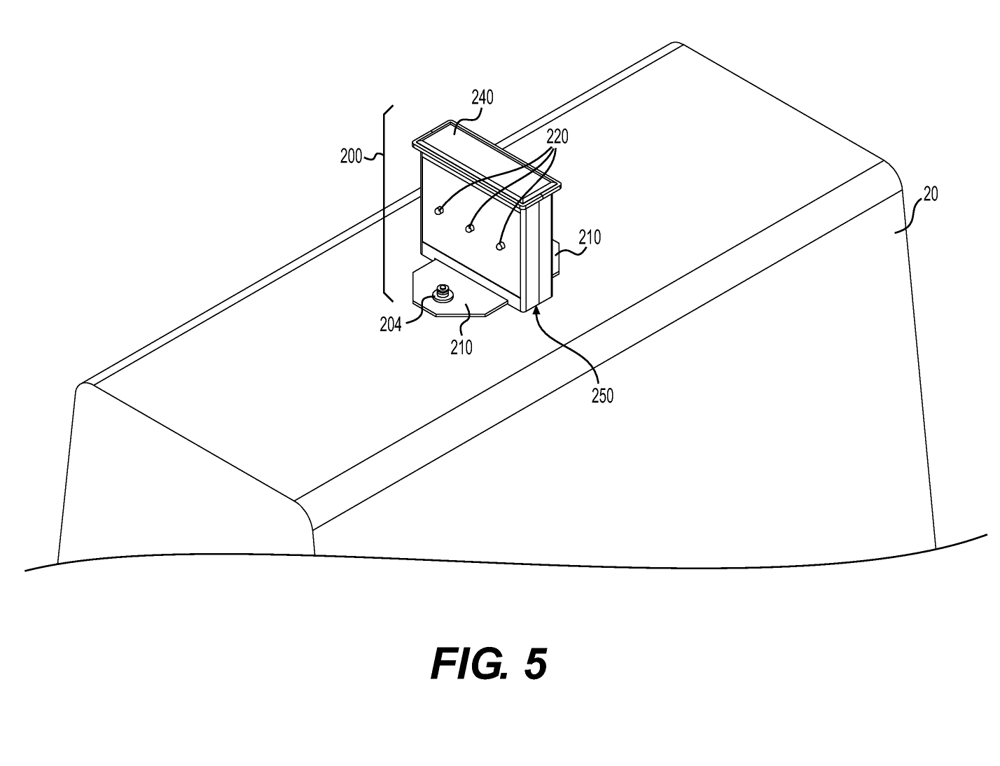

FIG. 5 shows an alternate embodiment of a delineator 200 in a perspective view, mounted on a roadway barrier 20. Delineator 200 comprises body 250, bolt mechanism 204, plurality of light sources 220, solar panel 240, and two mounting feet 210. In other embodiments, delineator 200 may include a plurality of light sources 220 on any side of body 202. Light sources 220 may also be on the top or sides of body 202.

Light sources 220 may be DIP and/or SMT LEDs, for example. In some embodiments, solar panel 240 may be a rectangular mono-crystalline solar panel. Alternatively, solar panel 240 can be any type of solar photovoltaic. For example, solar panel 240 may comprise Monocrystalline silicon (mono-Si), also called single-crystalline silicon (single-crystal-Si), Polycrystalline silicon, which also is known as polysilicon (p-Si), multi-crystalline silicon (mc-Si), Crystalline Silicon (c-Si), and thin-film photovoltaic cells (TFPV), among others.

Further, light sources 220 may comprise different colored LEDs. For example, three light sources 220 on the front of body 250 might emit white light, while an additional red LED may be placed on top of solar panel 240. The red LED may thus serve, in addition to a presence indicator, as a warning light indicating specific dangers to drivers. In further embodiments, light sources 220 and the warning lights may be any color. The warning lights may be the same or a different color as light sources 220. For example, the warning lights may be amber or yellow, while light sources 220 may be red. In further embodiments still, light sources 220 and/or the warning lights may be arranged in a specific shape or pattern, such as an arrow, an X, or a circle, and may indicate information including, but not limited to, road conditions, traffic patterns, construction delays, warnings, etc.

Delineator 200 might include a temperature sensor, wherein processor may be configured to illuminate light sources 220 when the temperature sensor detects a predetermined temperature. The temperature sensor may be a thermocouple connected to the processor. For example, the processor may be programmed to illuminate the red LED if the temperature falls below 32 degrees Fahrenheit. The warning light could be any color and placed at any point on the delineator. Further, delineator 100 may further comprise a plurality of light sources including at least one light source of a different color than the other light sources, wherein the processor may be configured to illuminate the light source of a different color when the temperature sensor detects a predetermined temperature.

In still further embodiments, the warning light could be controlled by the wireless signal. For example, the warning light could indicate a warning for an accident or a traffic jam ahead. Delineators 200 could be installed on a variety of surfaces, including roadway barriers, bridges, or an overpass. Further still, delineators 200 may be installed on highway equipment or any other mounting surface. In these positions, a plurality of wireless delineators 200 could potentially warn drivers of danger and serve to increase roadway safety.

Other embodiments will be apparent from consideration of the specification and practice of the exemplary embodiments and features disclosed herein. It is intended that the specification and examples be considered as exemplary only, with a true scope and spirit of the embodiments of the present disclosure being indicated by the following claims.

What is claimed is:

1. A roadway delineator, comprising:
a housing having a top member, a front member, and a back member:
the front member having:
a substantially vertical exterior surface defining a height and a width; and
an interior surface opposite the exterior surface; and
the top member being in a plane substantially perpendicular to the front member and having an exterior horizontal surface defining a depth, the depth being no greater than one half the height;
a solar cell array positioned on the top member;
a rechargeable power source;
a light source positioned on the front surface and electrically connected to the solar cell array and the power source;
a processor controlling electrical power between the solar cell array, the power source, and the light source; and
a foot having:
a horizontal mounting member extending parallel to the top member; and
a vertical member affixed to the interior surface of the front member.

2. The delineator of claim 1, wherein the horizontal mounting member includes a plurality of holes.

3. The delineator of claim 1, comprising a light sensor coupled to the processor wherein the processor is configured to illuminate the light source when the ambient lighting falls below a predetermined level.

4. The delineator of claim 1, including a hole in the foot, and a conductor connected to the power source that passes through the hole.

5. The delineator of claim 4, wherein the delineator is configured so that an electrical connection severs if the device is forcibly removed from a mounted state.

6. The delineator of claim 4, wherein the delineator is configured so that an electrical connection severs if the housing is separated from the foot.

7. The delineator of claim 5 or 6, further comprising a temperature sensor, wherein the processor is configured to illuminate the light source when the temperature sensor detects a predetermined temperature.

8. The delineator of claim 1, further comprising an optical lens configured to modify the output of the light source.

9. A roadway safety system, comprising:
a roadway barrier,
and a delineator comprising:
a housing having a top member, a front member, and a back member:
the front member having:
a substantially vertical exterior surface defining a height and a width; and
an interior surface opposite the exterior surface; and
the top member being in a plane substantially perpendicular to the front member and having an exterior horizontal surface defining a depth, the depth being no greater than one half the height;
a solar cell array positioned on the top member;
a rechargeable power source;
a light source positioned on the front surface and electrically connected to the solar cell array and the power source;
a processor controlling electrical power between the solar cell array, the power source, and the light source; and
a foot having:
a horizontal mounting member extending parallel to the top member; and
a vertical member affixed to the interior surface of the front member;
wherein the delineator is securely attached to the roadway barrier.

10. The roadway safety system of claim 9, wherein the delineator further comprises a wireless communication device.

11. The roadway safety system of claim 10, further comprising a plurality of delineators.

12. The roadway safety system of claim 11, wherein the plurality of delineators further comprise wireless communication devices.

13. The roadway safety system of claim 12, further comprising a wireless communication device capable of directing at least one of the plurality of delineators.

14. The roadway system of claim 9, the delineator further comprising a safety component configured such that an electrical connection supplying the processor is severed if it is separated from the roadway barrier.

15. The roadway system of claim 9, the delineator further comprising a temperature sensor, wherein the processor is configured to illuminate the light source when the temperature sensor detects a predetermined temperature.

16. The delineator of claim 15, further comprising a plurality of light sources including at least one light source of a different color than the other light sources, wherein the processor is configured to illuminate the light source of a different color when the temperature sensor detects a predetermined temperature.

17. A roadway delineator, comprising:
a housing;
a solar cell array;
a rechargeable power source;
a light source;
a processor controlling electrical power between the solar cell array, the power source, and the light source;
a mounting member; and
a temperature sensor,
wherein processor is configured to illuminate the light source when the temperature sensor detects a predetermined temperature.

18. The delineator of claim 17, further comprising a plurality of light sources including a warning light source of a different color than the light source,
wherein the processor is configured to illuminate the warning light source when the temperature sensor detects a predetermined temperature.

19. The delineator of claim 18, wherein the delineator is configured so that an electrical connection severs if the device is forcibly removed from a mounted state.
